(19) United States
(12) Patent Application Publication
(10) Pub. No.: US 2020/0301370 A1
(43) Pub. Date: Sep. 24, 2020

(54) MOVEMENT OF ELECTRONIC TIMEPIECE AND ELECTRONIC TIMEPIECE

(71) Applicant: CITIZEN WATCH CO., LTD., Nishitokyo-shi, Tokyo (JP)

(72) Inventors: Shinnosuke SAKATA, Kodaira-shi, Tokyo (JP); Daisuke NAKADAIRA, Shimoina-gun, Nagano (JP); Yoshikazu MATSUMURA, Shinjuku-ku, Tokyo (JP); Shoichiro MORITA, Kawagoe-shi, Saitama (JP); Yusuke HIROTA, Nishitokyo-shi, Tokyo (JP)

(21) Appl. No.: 16/645,161

(22) PCT Filed: Aug. 7, 2018
(86) PCT No.: PCT/JP2018/029625

§ 371 Date: Mar. 6, 2020

(30) Foreign Application Priority Data
Sep. 8, 2017 (JP) 2017-172946

(51) Int. Cl. G04C 3/14; G04G 17/02

(52) U.S. Cl. CPC G04C 3/14; G04G 17/02

(57) ABSTRACT

To lower magnetic influence on a stepping motor covered by a magnetic shielding plate in an electronic timepiece and a movement, a movement of an electronic timepiece includes a stepping motor having a rotor, a stator, and a coil in which a conductive wire is wound around a coil winding core; and a magnetic shielding plate that covers at least a part of the stepping motor, wherein the magnetic shielding plate includes slits as magnetic flow changing portions that change magnetic flows which are directed toward the coil winding core to magnetic flows which are not directed toward the coil winding core, and the slits are formed in portions of the magnetic shielding plate, which correspond to extended lines from both end portions of the coil winding core, respectively, to intersect with the extended lines.

### CROSS-REFERENCE TO RELATED APPLICATION

The present application is a national stage application of PCT Application No. PCT/JP2018/029625, filed on Aug. 7, 2018, which is based on and claims priority to Japanese Patent Application No. 2017-172946, filed on Sep. 8, 2017, the disclosures of which are hereby incorporated by reference in their entirety.

### TECHNICAL FIELD

This disclosure relates to a movement of an electronic timepiece and an electronic timepiece.

### BACKGROUND ART

In an electronic timepiece that drives a pointer by a stepping motor, a movement includes a magnetic shielding plate for protecting the stepping motor from an external magnetic field. The magnetic shielding plate generally covers the stepping motor from an upper side and a lower side thereof in a thickness direction. Recently, the electronic timepiece is diversified, and is provided with many stepping motors depending on respective functions. However, if each of the stepping motors is provided with the magnetic shielding plate, the number of magnetic shielding plates increases, resulting in an increase in costs.

Such an increase in costs is prevented by covering a plurality of stepping motors with a single large magnetic shielding plate (see JP2017-026461A, for example). The costs are further reduced by increasing the size of the magnetic shielding plate such that the magnetic shielding plate is also used as a bridge that supports a component except for the stepping motor, so as to eliminate the need for the bridge.

### SUMMARY

However, when the size of the magnetic shielding plate is increased, the magnetic shielding plate may cover, other than the stepping motor, a portion including a component that does not require a magnetic shielding performance. As the size of the magnetic shielding plate is increased, the more area of the magnetic shielding plate is exposed to an external magnetic field, resulting in an increase in magnetism flowing in the magnetic shielding plate.

The present disclosure has been made in view of the above circumstances, and an object of the present disclosure is to provide a movement of an electronic timepiece and a timepiece capable of reducing magnetic influence on the stepping motor covered by the magnetic shielding plate.

A first aspect of the present disclosure is a movement of an electronic timepiece, including: a stepping motor having a rotor, a stator, and a coil in which a conductive wire is wound around a coil winding core; and a magnetic shielding plate that covers at least a part of the stepping motor, wherein the magnetic shielding plate includes a magnetic flow changing portion that changes a magnetic flow which is directed toward the coil winding core to a magnetic flow which is not directed toward the coil winding core, and the magnetic flow changing portion is formed in a portion of the magnetic shielding plate, which corresponds to each of extended lines from both end portions of the coil winding core, to intersect with the extended line.

A second aspect of the present disclosure is an electronic timepiece in which the movement of the electronic timepiece according to the present disclosure is housed inside a case.

### BRIEF DESCRIPTION OF DRAWINGS

FIG. 1 is a partially transparent view illustrating one embodiment of an electronic timepiece according to the present disclosure, and representing a movement illustrated by a solid line, which is seen from a back cover side by virtually passing through a case illustrated by a two-dot chain line.

FIG. 2 is a plan view illustrating arrangement of a stepping motor and a magnetic shielding plate in the movement illustrated in FIG. 1.

FIG. 3 is a schematic view illustrating a slit having a longer side in a specific direction.

FIG. 4 is a schematic view illustrating a plurality of circular holes which play the same role as the slit in FIG. 3 and are arranged in the specific direction.

FIG. 5 is a plan view illustrating arrangement of a stepping motor and a magnetic shielding plate in a movement of Modified Example 1.

FIG. 6 is a plan view illustrating arrangement of a stepping motor and a magnetic shielding plate in a movement of Modified Example 2.

FIG. 7 is a schematic view illustrating a variation (Modified Example 3) of arrangement of two stepping motors and formation of slits in a magnetic shielding plate when a movement of an electronic timepiece according to another embodiment of the present disclosure includes the two stepping motors.

FIG. 8 is a schematic view illustrating a variation (Modified Example 4) of arrangement of two stepping motors and formation of slits in a magnetic shielding plate when a movement of an electronic timepiece according to another embodiment of the present disclosure includes the two stepping motors.

FIG. 9 is a schematic view illustrating a variation (Modified Example 5) of arrangement of two stepping motors and formation of slits in a magnetic shielding plate when a movement of an electronic timepiece according to another embodiment of the present disclosure includes the two stepping motors.

FIG. 10 is a schematic view illustrating a variation (Modified Example 6) of arrangement of two stepping motors and formation of slits in a magnetic shielding plate when a movement of an electronic timepiece according to another embodiment of the present disclosure includes the two stepping motors.

FIG. 11 is a schematic view illustrating a variation (Modified Example 7) of arrangement of a stepping motor and formation of slits in a magnetic shielding plate when a movement of the electronic timepiece according to another embodiment of the present disclosure includes two coils.

FIG. 12 is a schematic view illustrating Modified Example in which a battery (one example of magnetic material) is arranged instead of the single stepping motor in FIG. 7.

### DETAILED DESCRIPTION

Hereinafter, an embodiment of a movement of an electronic timepiece and an electronic timepiece according to the present disclosure will be described with reference to the drawings.

### <Configuration of Electronic Timepiece>

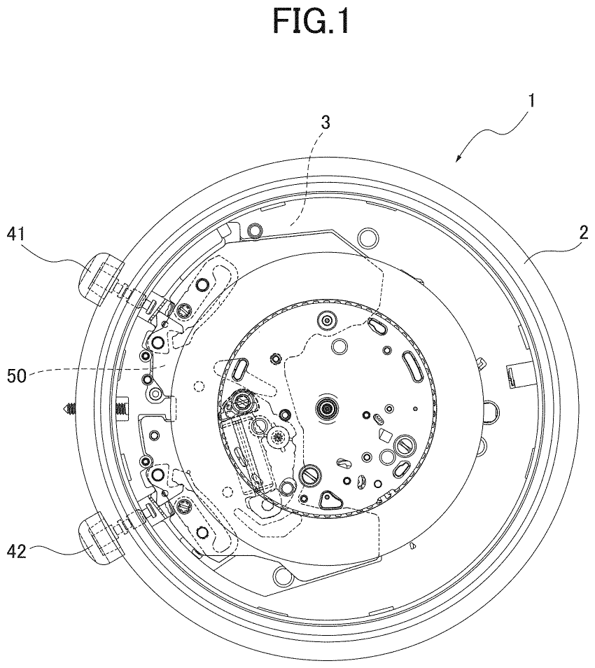

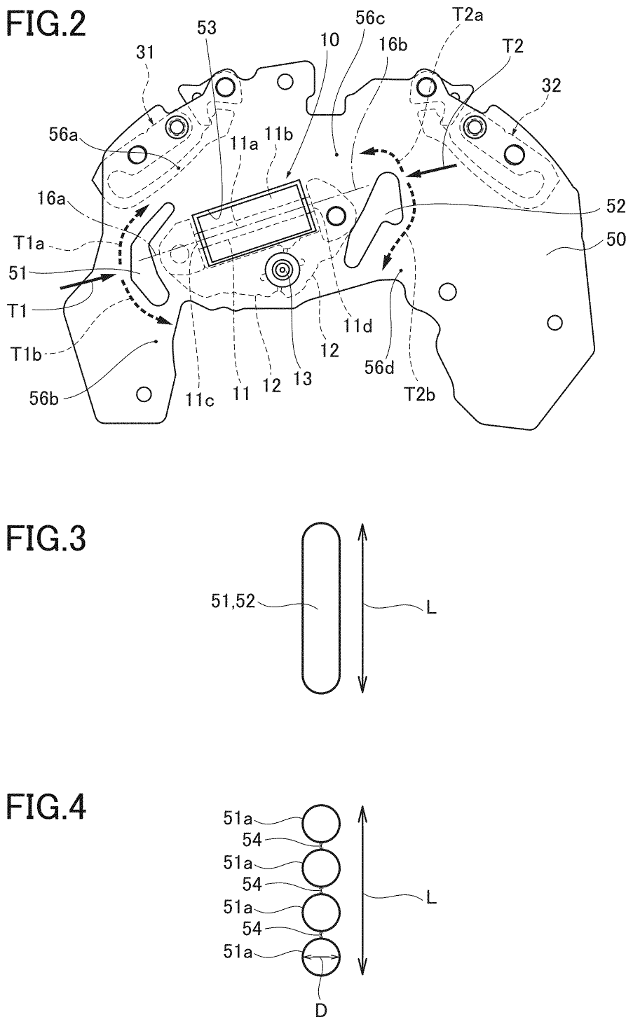

FIG. 1 is a partially transparent view illustrating an electronic timepiece 1 as one embodiment of the electronic timepiece according to the present disclosure, and representing a movement 3 illustrated by a solid line, which is seen from a back cover side virtually passing through a case 2 illustrated by a two-dot chain line. FIG. 1 shows, in an upper side thereof, a 12 o'clock direction and, in a left side thereof, a 3 o'clock direction. FIG. 2 is a plan view illustrating the arrangement of a stepping motor 10 and a magnetic shielding plate 50 in the movement 3 illustrated in FIG. 1.

In the electronic timepiece 1, the movement 3 is housed inside the metal case 2. The electronic timepiece 1 is a radio controlled timepiece including an operation that receives radio wave, and automatically corrects a pointer for indicating a time with the movement 3 based on the received radio wave. The electronic timepiece 1 includes a solar cell panel and a secondary battery, generates electricity with the solar cell panel, and drives the movement 3 by electric power stored in the secondary battery.

### <Configuration of Movement>

The movement 3 is one embodiment of a movement of an electronic timepiece according to the present disclosure. The movement 3 includes the stepping motor 10, push buttons (PB) 41, 42, PB click springs 31, 32 (refer to FIG. 2), and the magnetic shielding plate 50. The stepping motor 10 drives a train wheel for rotating a pointer for displaying a time with supplied electric power stored in the secondary battery. A user pushes the push buttons (PB) 41, 42 for switching various operations of the electronic timepiece 1 and for inputting a specific operation. The PB click springs 31, 32 (refer to FIG. 2) produce a click feeling as a reaction force of a pushed operation.

In addition to the above-described configurations, the movement 3 includes a mechanism of manually correcting an indicated position of a pointer, another mechanism, and another component. However, they are not necessary for describing the electronic timepiece 1 of the present embodiment, and the description for them are thus omitted.

As illustrated in FIG. 2, the stepping motor 10 includes a coil 11, stators 12, and a rotor 13. The coil 11 includes a linearly extending coil winding core 11a and a conductive wire lib. The conductive wire 11b is spirally wound around the coil winding core 11a. The stators 12 are connected to a first end portion 11c of the coil winding core 11a and a second end portion 11d of the coil winding core 11a. The stators 12 also have an end portion opposite to the end portion connected to the first end portion 11c and an end portion opposite to the end portion connected to the second end portion 11d, respectively. These end portions of the stators 12 face to each other across the rotor 13.

As illustrated in FIG. 2, the magnetic shielding plate 50 is arranged to cover the entire stepping motor 10 except for the coil 11 in a plan view. The coil 11 of the stepping motor 10 has a thickness larger than those of the stators 12 and the rotor 13. The magnetic shielding plate 50 therefore includes an opening portion 53 through which the coil 11 passes in the thickness direction, so as to prevent interference with the coil 11.

In addition, although the magnetic shielding plate 50 may cover the coil 11, it is not necessary to cover the entire stepping motor 10. More specifically, the magnetic shielding plate 50 should cover at least the rotor 13, a portion over an extended line 16a in an extending direction of the coil winding core 11a from the first end portion 11c, and a portion over an extended line 16b in an extending direction of the coil winding core 11a from the second end portion 11d.

As the magnetic shielding plate 50 is to prevent or control magnetism, which is generated and flown inside the electronic timepiece 1 due to the external magnetic field of the electronic timepiece 1, from flowing in the stepping motor 10, the magnetic shielding plate 50 is originally required to have a size that covers only the stepping motor 10. On the other hand, the magnetic shielding plate 50 of the present embodiment has a size larger than that of the stepping motor 10. A part of the magnetic shielding plate 50 (that is not required to serve as magnetic shielding plate 50) except for a part of the magnetic shielding plate 50 that covers the stepping motor 10 serves as a bridge that supports, for example, the train wheel and the PB click springs 31, 32.

Although the movement 3 of the present embodiment includes only the single stepping motor 10, the movement 3 may include two or more stepping motors 10. Even when the movement 3 includes the two or more stepping motors 10, the single magnetic shielding plate 50 can cover the two or more stepping motors 10. Accordingly, such a configuration having the single magnetic shielding plate 50 can reduce the costs to be lower than that of a configuration having a plurality of small magnetic shielding plates to be provided for a plurality of stepping motors, respectively.

The magnetic shielding plate 50 also supports the PB click springs 31, 32, for example. The configuration having such a magnetic shielding plate 50 can reduce the costs to be lower than that of a configuration having a bridge that supports the PB click springs 31, 32, in addition to the magnetic shielding plate 50.

Slits 51, 52 intersecting with the extended lines 16a, 16b, respectively, are formed in parts (portions corresponding to extended lines) of the magnetic shielding plate 50 that cover the extended lines 16a, 16b in the longitudinal direction of the coil winding core 11a from both of the end portions 11c, 11d of the coil winding core 11a. These slits 51, 52 have a length in the longitudinal direction (direction intersecting with extended lines 16a, 16b) larger (longer) than a diameter of the coil 11 in which the conductive wire 11b is wound around the coil winding core 11a. These slits 51, 52 have, over the extended lines 16a, 16b, a width in the width direction (direction along extended lines 16a, 16b (longitudinal direction of coil winding core 11a)) larger (wider) than the diameter of the coil winding core 11a.

According to the movement 3 and the electronic timepiece 1 configured as described above, the direction of the external magnetic field that may affect the operation of the stepping motor 10 corresponds to the longitudinal direction of the coil 11 of the stepping motor 10. As illustrated in FIG. 2, when the magnetic shielding plate 50 in the present embodiment is exposed by the external magnetic field which causes a magnetic flow T1 directed toward the coil 11 from the direction of the extended line 16a of the coil 11, the magnetic flow T1 in the magnetic shielding plate 50 is blocked by the slit 51 formed near the coil 11 from flowing in the coil 11.

The magnetic flow T1 is then changed to flows T1a, T1b which are not directed toward the coil 11, namely, which are directed along an end portion of the magnetic shielding plate 50 outside the slit 51. Namely, the slit 51 is one example of a magnetic flow changing portion that changes the magnetic flow T1 which is directed toward the coil 11 to the magnetic flow which is not directed toward the coil 11.

As illustrated in FIG. 2, when the magnetic shielding plate 50 in the present embodiment is exposed by the external magnetic field which causes a magnetic flow T2 directed toward the coil 11 from the direction of the extended line 16b of the coil 11, the magnetic flow T2 in the magnetic shielding plate 50 is blocked by the slit 52 formed near the coil 11 from flowing in the coil 11.

The magnetic flow T2 is then changed to flows T2a, T2b which are not directed toward the coil 11, namely, which are directed along the end portion of the magnetic shielding plate 50 outside the slit 52. Namely, the slit 52 is one example of the magnetic flow changing portion that changes the magnetic flow T2 which is directed toward the coil 11 to the magnetic flow which is not directed toward the coil 11.

As described above, according to the movement 3 of the electronic timepiece 1 and the electronic timepiece 1 of the present embodiment, the magnetic flows T1, T2 in the longitudinal direction of the coil 11 by which the stepping motor 10 is easily most affected are prevented or controlled from flowing in the stepping motor 10 covered by the magnetic shielding plate 50. It may therefore become difficult for the stepping motor 10 covered by the magnetic shielding plate 50 to be affected by the magnetic flows T1, T2.

The magnetic flow T1a having a direction changed by the slit 51 is directed toward a supporting portion 56a that supports the PB click spring 31 as one example of a component which does not require a magnetic shielding performance. The magnetic flow T1b having a direction changed by the slit 51 is also directed to a supporting portion 56b that supports a component except for the stepping motor 10. Accordingly, the movement 3 and the electronic timepiece 1 of the present embodiment can effectively use portions that receive the magnetic flows T1a, T1b (magnetic flow bypass portion that bypasses magnetic flow T1) as the supporting portions 56a, 56b.

Similarly, the magnetic flow T2a having a direction changed by the slit 52 is directed toward a supporting portion 56c that supports the PB click spring 32 as one example of a component which does not require the magnetic shielding performance. The magnetic flow T2b having a direction changed by the slit 52 is directed to a supporting portion 56d that supports a component except for the stepping motor 10. Accordingly, the movement 3 and the electronic timepiece 1 of the present embodiment can effectively use portions that receive the magnetic flows T2a, T2b (magnetic flow bypass portion that bypasses magnetic flow T2) as the supporting portions 56c, 56d.

In the movement 3 of the electronic timepiece 1 and the electronic timepiece 1 of the present embodiment, the slits 51, 52 penetrating through the magnetic shielding plate 50 in the thickness direction are provided as the magnetic flow changing portions in the present disclosure. However, the magnetic flow changing portion is not limited to a slit having a longer side in a specific direction. More specifically, the magnetic flow changing portion in the present disclosure may be a hole penetrating through the magnetic shielding plate 50 in the thickness direction or may be a cutout formed in an end portion of the magnetic shielding plate 50. The hole may have a circular shape, a rectangular shape, or another shape.

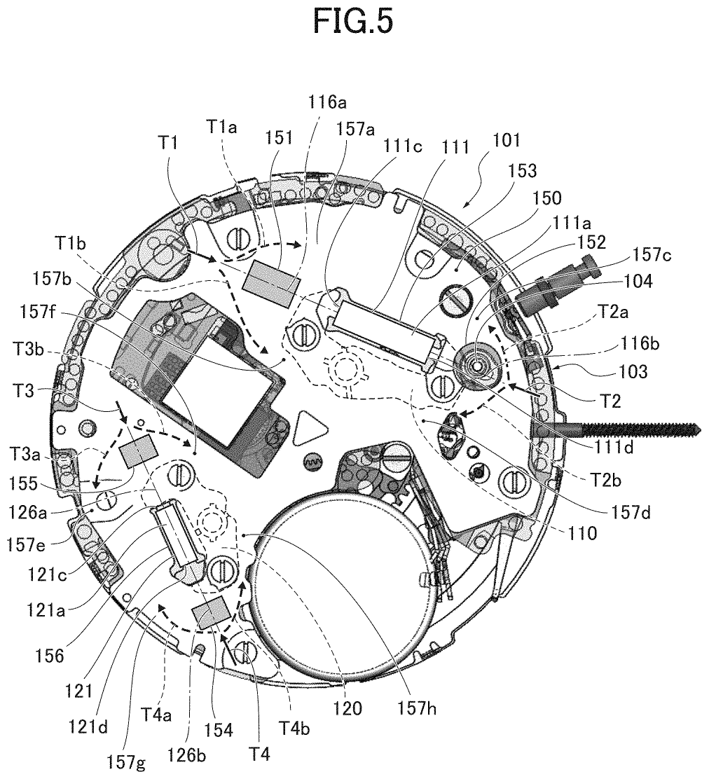

As illustrated in FIG. 3, the slits 51, 52 are formed to have an elongated shape having a length in the longitudinal direction as L. However, as illustrated in FIG. 4, for example, a plurality of circular holes 51a may be formed instead of the elongated slits 51, 52. In this case, the circular holes 51a are arranged in a line at intervals 54, and each of the circular holes 51a has a diameter D L) having a length in the longitudinal direction smaller than that of each of the slits 51, 52.

By forming the magnetic flow changing portion with a plurality of holes 51a instead of the single long slit 51, 52, a strength of the magnetic shielding plate 50 may be maintained stronger than that of the magnetic shielding plate 50 in which the single slit 51, 52 is formed because the portions of the intervals 54 remain as the magnetic shielding plate 50. In addition, the number of circular holes 51 to be arranged may be the number corresponding to the length L of the single slit 51, 52 in the longitudinal direction.

The slits 51, 52 are not limited to a shape having the same width in any position in the longitudinal direction. The slits 51, 52 may be a shape having a different width in each position in the longitudinal direction. When the slits 51, 52 are substituted with a plurality of circular holes 51a, it may not be necessary for a plurality of holes 51a to have the same diameter D. Moreover, the slits 51, 52 are not limited to a shape having an approximate I shape external outline, and may be a shape having a different external outline such as a C shape and an L shape.

The magnetic flow changing portion in the present disclosure is not limited as long as it is configured to change the magnetic flows T1, T2 which are directed toward the coil 11 to the magnetic flows T1a, T1b, T2a, T2b which are not directed toward the coil 11. Namely, the magnetic flow changing portion in the present disclosure is not limited as long as it is configured such that the magnetism easily flows in the directions different from the direction of the coil 11 rather than the direction of the coil 11. Accordingly, instead of the slits 51, 52 that penetrate through the magnetic shielding plate 50 in the thickness direction as the magnetic flow changing portion, a groove having a longer side in a specific direction may be provided. Such a groove has a thickness smaller than that of another portion. Instead of the hole that penetrates through the magnetic shielding plate 50 in the thickness direction, a recess (concave portion) having a thickness smaller than that of another portion may be provided.

In the movement 3 of the electronic timepiece 1 and the electronic timepiece 1 of the present embodiment, the slits 51, 52 are formed outside both of the end portions 11c, 11d of the coil 11. It is necessary for the slits 51, 52 to be formed to correspond to the outsides of both of the end portions 11c, 11d of the coil 11. If the magnetic flow is fixed in one direction, the slits 51, 52 may be provided only in a portion corresponding to the first end portion 11c of the coil 11 or the second end portion 11d of the coil 11 such that the slits are suitable only for the magnetism in the one direction of the flow.

When the electronic timepiece 1 is a watch to be carried to various places, it is, however, rare that such a watch is used in an environment where the magnetic flow is fixed in one direction. Accordingly, it is practically preferable for the slits 51, 52 to be formed in the portions of the magnetic shielding plate 50 that correspond to the outsides of both of the end portions 11c, 11d of the coil 11.

The slits 51, 52 in the present embodiment extend along the external outline of the stators 12 to surround a part of the stators 12 from the outside. Such slits can effectively eliminate the influence of the external magnetic field to the stators 12. However, the magnetic flow changing portion in the present disclosure may not be limited to a shape along the external outline of the stators.

In the present embodiment, the length of the slits 51, 52 in the longitudinal direction is larger than the diameter of the coil 11, and the width of the slits 51, 52 is larger than the diameter of the coil winding core 11a. However, in the present disclosure, the length of the magnetic flow changing portion in the longitudinal direction may be smaller than the diameter of the coil 11, and the width of the magnetic flow changing portion may be smaller than the diameter of the coil winding core 11a.

The supporting portions 56a, . . . , 56d of the magnetic shielding plate 50 are not limited to the portions that support the PB click springs 31, 32, and may be portions that support other components of the movement 3. The supporting portions 56a, . . . , 56b are not limited to the portions that support components, and may serve as portions that receive the magnetic flows T1a, T1b, T2a, T2b whose directions are changed by the slits 51, 52.

In addition, when the movement has a plurality of stepping motors, a portion that covers the stepping motor having a lowest frequency of use may be used as a portion in which the magnetism flows as the supporting portion.

### Modified Example 1

FIG. 5 is a plan view illustrating arrangement of stepping motors 110, 120 in a movement 103 of an electronic timepiece 101 and a magnetic shielding plate 150 as another embodiment (Modified Example 1) of the present disclosure. The illustrated electronic timepiece 101 has the same basic configuration as the electronic timepiece 1 illustrated in FIG. 1, and only differs from the electronic timepiece 1 illustrated in FIG. 1 in the movement 103.

Different from the movement 3, the movement 103 includes the two stepping motors 110, 120, and a single magnetic shielding plate 150 covers the two stepping motors 110, 120.

In addition to a hole 153 that avoids a coil 111 of the stepping motor 110 and a hole 156 that avoids a coil 121 of the stepping motor 120, holes 151, 152 intersecting with extended lines 116a, 116b, respectively, are formed in portions (portions corresponding to extended lines) of the magnetic shielding plate 150, which cover the extended lines 116a, 116b of a coil winding core 111a in the longitudinal direction from both end portions 111c, 111d of the coil winding core 111a of the coil 111.

Similarly, holes 154, 155 intersecting with extended lines 126a, 126b, respectively, are formed in portions (portions corresponding to extended lines) of the magnetic shielding plate 150, which cover the extended lines 126a, 126b of a coil winding core 121a in the longitudinal direction from both end portions 121c, 121d of the coil winding core 121a of the coil 121.

When the movement 103 and the electronic timepiece 101 configured above are exposed by an external magnetic field that generates magnetic flows T1, T2 toward the coil 111 from the directions of the extended lines 116a, 116b of the coil 111, the magnetic flows T1, T2 in the magnetic shielding plate 150 are blocked by the rectangular hole 151 and the circular hole 152 formed near the coil 111 from flowing in the coil 111, and are changed to flows T1a, T1b, T2a, T2b which are not directed toward the coil 111.

The magnetic shielding plate 150 includes supporting portions 157a, 157b, 157c, 157d (it is not necessary for supporting portions to actually support specific components as long as they include areas that can support components) that support other components except for the stepping motors 110, 120, and the supporting portions receive the flows T1a, T1b, T2a, T2b which are not directed toward the coil 111. That is, the magnetic shielding plate 150 effectively uses the portions receiving the magnetic flows T1a, T1b, T2a, T2b as the supporting portions 157a, 157b, 157c, 157d.

Similarly, when the movement 103 and the electronic timepiece 101 are exposed by an external magnetic field that generates magnetic flows T3, T4 which are directed toward the coil 121 from the directions of the extended lines 126a, 126b of the coil 121, the magnetic flows T3, T4 in the magnetic shielding plate 150 are blocked by the rectangular holes 154, 155 formed near the coil 121 from flowing in the coil 121, and are changed to flows T3a, T3b, T4a, T4b which are not directed toward the coil 121.

The magnetic shielding plate 150 includes supporting portions 157e, 157f, 157g, 157h (it is not necessary for supporting portions to actually support specific components as long as they include portions that can support components) that support other components except for the stepping motors 110, 120 as the portions that receive the flows T3a, T3b, T4a, T4b which are not directed toward such a coil.

As described above, according to the movement 103 of the electronic timepiece 101 and the electronic timepiece 101, the magnetic flows T1, T2 in the longitudinal direction of the coil 111 by which the stepping motor 110 is easily affected can be prevented or controlled from flowing in the stepping motor 110 covered by the magnetic shielding plate 150, and the magnetic flows T3, T4 in the longitudinal direction of the coil 121 by which the stepping motor 120 is easily affected can be prevented or controlled from flowing in the stepping motor 120 covered by the magnetic shielding plate 150. It becomes difficult for the stepping motor 110 covered by the magnetic shielding plate 150 to be affected by the magnetic flows T1, T2, and it becomes also difficult for the stepping motor 120 covered by the magnetic shielding plate 150 to be affected by the magnetic flows T3, T4.

According to the movement 103 of the electronic timepiece 101 and the electronic timepiece 101, the single magnetic shielding plate 150 covers the two stepping motors 110, 120. Such a configuration reduces the costs to be lower than that of a configuration in which two magnetic shielding plates cover two stepping motors, respectively.

Moreover, as the holes 151, 152, 154, 155 as the magnetic flow changing portions are formed in the magnetic shielding plate 150 in accordance with the stepping motors 110, 120, respectively, all of the stepping motors 110, 120 are controlled from being affected by the external magnetic field.

In addition, in the movement 103, another component 104 (for example, conductive spring for alarm) arranged in a range corresponding to a range inside the external outline of the magnetic shielding plate 150 may be arranged in the hole 152 as the magnetic flow changing portion. Such a configuration which arranges another component 104 in the hole 152 allows a space to be used more effectively than a configuration that uses the hole 152 only as the magnetic flow changing portion.

### Modified Example 2

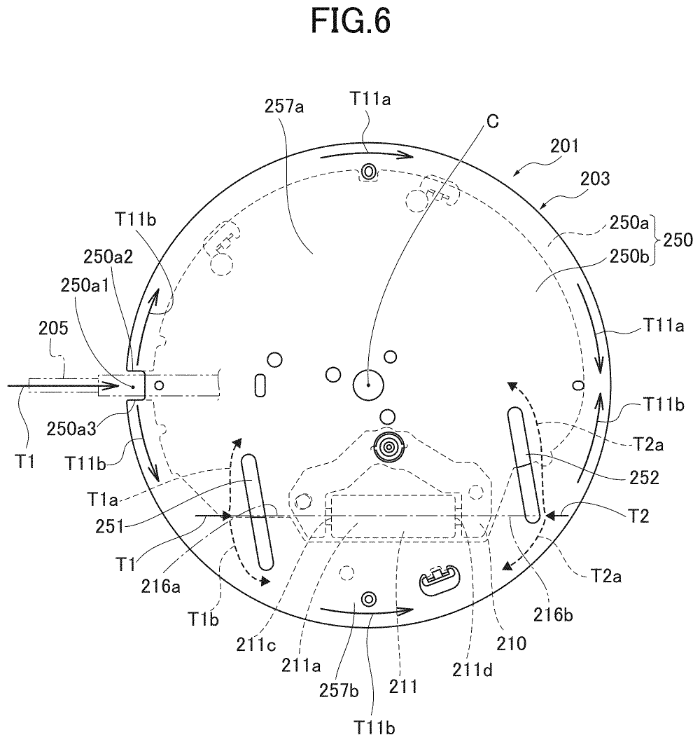

FIG. 6 is a plan view illustrating arrangement of a stepping motor 210 and a magnetic shielding plate 250 in a movement 203 of an electronic timepiece 201 as another embodiment (Modified Example 2) of the present disclosure. The illustrated electronic timepiece 201 includes the same basic configuration as the electronic timepiece 1 illustrated in FIG. 1, and only differs from the electronic timepiece 1 illustrated in FIG. 1 in the movement 203.

Different from the movement 3, in the movement 203, a magnetic shielding plate 250 that covers the stepping motor 210 includes a ring like magnetic shielding plate 250a (hereinafter, ring magnetic shielding plate) that covers an outer circumference portion of the movement 203 and a plate like magnetic shielding plate 250b (hereinafter, “plate magnetic shielding plate”) that covers the entire movement 203 including the ring magnetic shielding plate 250a.

The ring magnetic shielding plate 250a is formed along an external form of the movement 203. The ring magnetic shielding plate 250a includes, in a part thereof (for example, 3 o'clock position of timepiece 201), a cutout. A winding stem 205 is provided at a position (portion overlapped with cutout 250a1 in plan view) corresponding to the cutout portion (cutout) 250a1. The winding stem 205 extends from the outside of the ring magnetic shielding plate 250a in a direction toward a center C of the movement 203 (center of ring of ring magnetic shielding plate 250a), and is inserted through the inside of the ring magnetic shielding plate 250a.

The ring magnetic shielding plate 250a does not overlap with the stepping motor 210 in the thickness direction, but is arranged to surround the stepping motor 210 from the outside in the radial direction of the movement 203, and shields the magnetic flow to the movement 203 from the external magnetic field of the movement 203. The ring magnetic shielding plate 250a is arranged outside the stepping motor 210 and outside two slits 251, 252 formed in the after-described plate magnetic shielding plate 250b. On the other hand, the plate magnetic shielding plate 250b overlaps with the stepping motor 210 in the thickness direction to cover the stepping motor 210. The plate magnetic shielding plate 250b overlaps with the winding stem 205 in the thickness direction to cover the winding stem 205.

Although the plate magnetic shielding plate 250b is originally a bridge that supports a film solar cell disposed in a top surface of the plate magnetic shielding plate 250b, this bridge also serves as a magnetic shielding plate. The slits 251, 252 intersecting with extended lines 216a, 216b, respectively, are formed in portions (portions corresponding to extended lines) of the plate magnetic shielding plate 250b. These portions cover the extended lines 216a, 216b in the longitudinal direction of a coil winding core 211a from both end portions 211c, 211d of the coil winding core 211a of a coil 211 of the stepping motor 210. The ring magnetic shielding plate 250a and the plate magnetic shielding plate 250b are arranged to sandwich a not shown main plate in the thickness direction. In addition, the ring magnetic shielding plate 250a may contact the plate magnetic shielding plate 250b.

When the movement 203 and the electronic timepiece 201 configured as described above are exposed by the external magnetic field that generates magnetic flows T1, T2 toward the coil 211 from the directions of the extended lines 216a, 216b of the coil 211, the magnetic flows T1, T2 in the plate magnetic shielding plate 250b are blocked by the slits 251, 252 formed near the coil 211 from flowing in the coil 211, and are changed to flows T1a, T1b, T2a, T2b which are not directed toward the coil 211.

Although the plate magnetic shielding plate 250b includes supporting portions 257a, 257b that support other components except for the stepping motor 210 as portions that receive the flows T1a, T1b, T2a, T2b which are not directed toward the coil 211, these portions that receive the magnetic flows T1a, T1b, T2a, T2b are effectively used as the supporting portions 257a, 257b.

As described above, according to the movement 203 of the electronic timepiece 201 and the electronic timepiece 201, the magnetic flows T1, T2 in the longitudinal direction of the coil 211 by which the stepping motors 210 are easily most affected are prevented or controlled from flowing in the stepping motor 210 covered by the plate magnetic shielding plate 250b. It becomes difficult for the stepping motor 210 covered by the plate magnetic shielding plate 250b to be affected by the magnetic flows T1, T2.

The electronic timepiece 201 includes a configuration in which the stepping motor 210 is arranged such that the extended lines 216a, 216b of the coil winding core 211a become parallel or substantially parallel (hereinafter, simply substantially parallel) to the direction of the cutout 250a1 (direction connecting cutout 250a1 and center C of ring of ring magnetic shielding plate 250a) of the ring magnetic shielding plate 250a including, in a part thereof in the circumference direction, the cutout 250a1 through which the winding stem 205 is inserted. As described above, by disposing the stepping motor 210 such that the extended lines 216a, 216b of the coil winding core 211a become substantially parallel to the direction of the cutout 250a1 of the ring magnetic shielding plate 250a, the magnetic shielding performance with the ring magnetic shielding plate 250a and the plate magnetic shielding plate 250b is further improved with respect to the stepping motor 210.

Namely, as illustrated in FIG. 6, the magnetic flow T1 substantially parallel to the coil winding core 211a generated by the external magnetic field flows in the ring magnetic shielding plate 250a in addition to the plate magnetic shielding plate 250b. More specifically, a part of the magnetic flow T1 is guided inside the ring magnetic shielding plate 250a from each of end portions 250a2, 250a3 of the ring magnetic shielding plate 250a, that face each other via the cutout 250a1. A magnetic flow T11a guided inside the ring magnetic shielding plate 250a from the end portion 250a2 flows inside the ring magnetic shielding plate 250a in the clockwise direction, and a magnetic flow T11b guided inside the ring magnetic shielding plate 250a from the end portion 250a3 flows inside the ring magnetic shielding plate 250a in the counterclockwise direction.

A part of the magnetic flow T1 substantially parallel to the coil winding core 211a, which is guided to the plate magnetic shielding plate 250b flows away from the coil winding core 211a by the slits 251, 252, and a part of the magnetic flow T1 which is not guided to the plate magnetic shielding plate 250b is guided to the ring magnetic shielding plate 250a, and also flows away from the coil winding core 211a. According to the movement 203 of the electronic timepiece 201 and the electronic timepiece 201, the magnetic shielding performance to the stepping motor 210 can be further improved with respect to the magnetic flow T1 substantially parallel to the coil winding core 211a.

When the stepping motor 210 is arranged such that the direction of the cutout 250a1 of the ring magnetic shielding plate 250a becomes substantially parallel to the extended lines 216a, 216b of the coil winding core 211a (in FIG. 6, when cutout 250a1 of ring magnetic shielding plate 250a is formed in 12 o'clock position (upper side of figure) or 6 o'clock position (lower side of figure)), a part of the magnetic flow T1 is guided inside the ring magnetic shielding plate 250a, and becomes the flow T11a in the clockwise direction and the flow T11b in the counterclockwise direction inside the ring magnetic shielding plate 250a.

However, when the cutout 250a1 is formed in the 12 o'clock position, the magnetic flow T11a in the clockwise direction is blocked by the cutout 250a1, and flows from the cutout 250a1 to the plate magnetic shielding plate 250b to be the magnetic flow toward the coil winding core 211a which may affect the coil winding core 211a. When the cutout 250a1 is formed in the 6 o'clock position, the magnetic flow T11b in the counterclockwise direction is blocked by the cutout 250a1, and flows from the cutout 250a1 in the plate magnetic shielding plate 250b to be the magnetic flow toward the coil winding core 211a, which may affect the coil winding core 211a. In addition, the magnetic flow T2 whose direction is opposite to that of the magnetic flow T1 is also blocked, and flows similar to the above magnetic flow T1.

As described in details, by disposing the stepping motor 210 such that the extended lines 216a, 216b of the coil winding core 211a becomes substantially parallel to the direction of the cutout 250a1 of the ring magnetic shielding plate 250a, the magnetic shielding performance to the stepping motor 210 by the ring magnetic shielding plate 250a and the plate magnetic shielding plate 250b is further improved to be better than that when the stepping motor 210 is arranged such that the extended lines 216a, 216b of the coil winding core 211a do not become substantially parallel to the direction of the cutout 250a1 of the ring magnetic shielding plate 250a (for example, stepping motor 210 is arranged such that extended lines 216a, 216b of coil winding core 211a become substantially orthogonal to direction of cutout 250a1 of ring magnetic shielding plate 250a).

According to the electronic timepiece and the movement of the present disclosure, the stepping motor is not limited to be arranged such that the extended lines of the coil winding core become parallel to the direction of the cutout of the ring magnetic shielding plate as described above.

### Another Modified Example

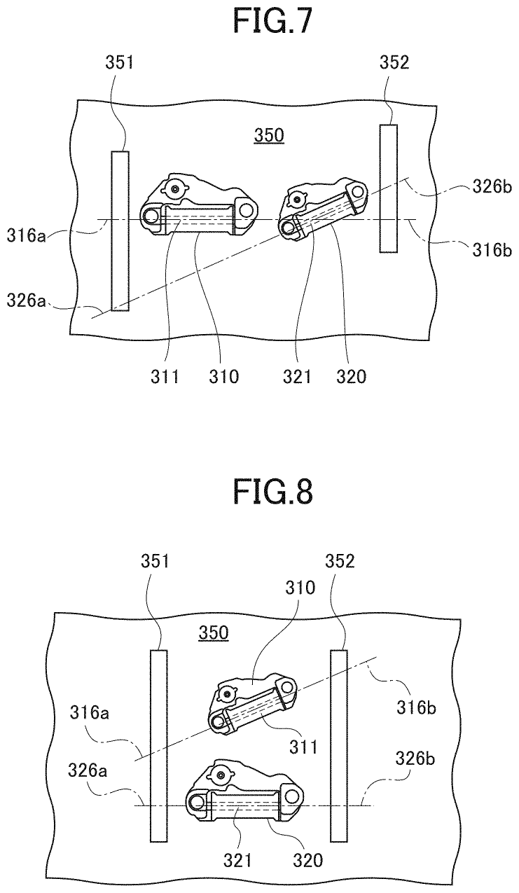

FIGS. 7, 8, 9, 10, 11 are schematic views illustrating variations (Modified Examples 3 to 7) of arrangement of two stepping motors 310, 320 and formation of slits 351, 352, 353 in a magnetic shielding plate 350 when the movement of the electronic timepiece as another embodiment of the present disclosure includes the two stepping motors 310, 320.

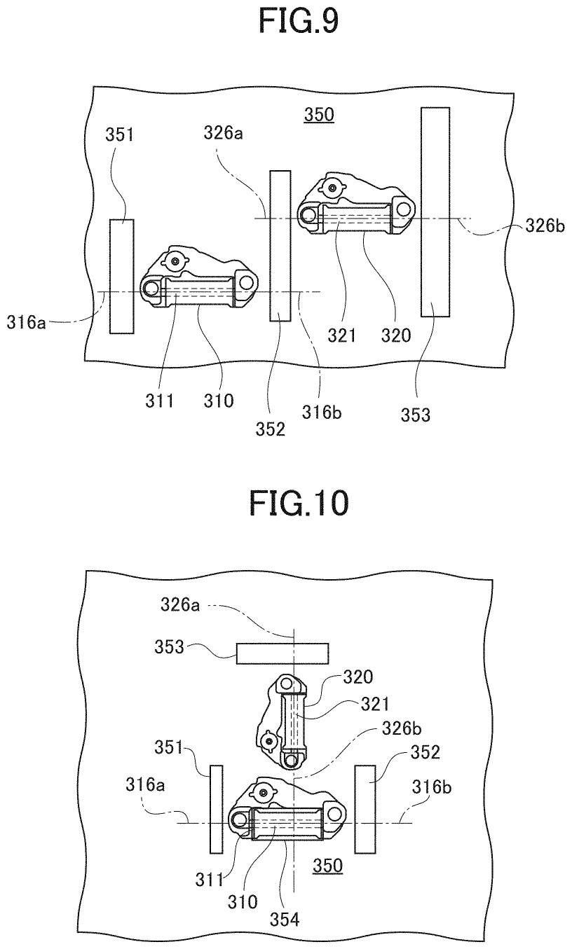

When the coils 311, 321 of the two stepping motors 310, 320 are arranged in substantial parallel (FIGS. 7, 8, 9), the slits 351, 352 as the magnetic flow changing portions of the magnetic shielding plate 350 may be shared by the two coils 311, 321, respectively, as illustrated in FIGS. 7, 8, or the slit 352 between the two coils 311, 321 may be only shared, as illustrated in FIG. 9.

More specifically, as illustrated in FIGS. 7, 8, the slit 351 is formed to intersect with an extended line 316a of the coil 311 of the stepping motor 310 in the longitudinal direction and an extended line 326a of the coil 321 of the stepping motor 320 in the longitudinal direction while the slit 352 is formed to intersect with an extended line 316b of the coil 311 of the stepping motor 310 in the longitudinal direction and an extended line 326b of the coil 321 of the stepping motor 320 in the longitudinal direction.

As illustrated in FIG. 9, the slit 351 is formed to intersect with the extended line 316a of the coil 311 of the stepping motor 310 in the longitudinal direction, the slit 352 is formed to intersect with the extended line 316b of the coil 311 of the stepping motor 310 in the longitudinal direction and the extended line 326a of the coil 321 of the stepping motor 320 in the longitudinal direction, and the slit 353 is formed to intersect with the extended line 326b of the coil 321 of the stepping motor 320 in the longitudinal direction.

On the other hand, when both of the coils 311, 312 of the two stepping motors 310, 320 are arranged to be substantially orthogonal to each other (FIG. 10), two slits are formed with respect to each of the stepping motors 310, 320. More specifically, the slit 351 is formed to intersect with the extended line 316a of the coil 311 of the stepping motor 310 in the longitudinal direction, the slit 352 is formed to intersect with the extended line 316b of the coil 311 of the stepping motor 310 in the longitudinal direction, the slit 353 is formed to intersect with the extended line 326a of the coil 321 of the stepping motor 320 in the longitudinal direction, and a slit 354 is formed to intersect with the extended line 326b of the coil 321 of the stepping motor 320 in the longitudinal direction.

However, when the extended line 326b of the coil 321 of the stepping motor 320 in the longitudinal direction is arranged to intersect with the coil 311 of the stepping motor 310, a hole through which the coil 311 is inserted is formed in the magnetic shielding plate 350, and the hole can be therefore used as the slit 354.

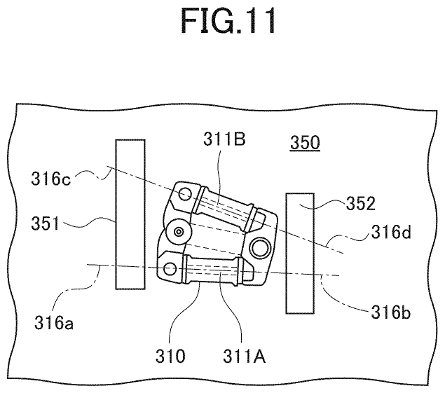

As illustrated in FIG. 11, when the stepping motor 310 includes two coils 311A, 311B, the slit 351 is formed to intersect with the extended line 316a of the coil 311A in the longitudinal direction and the extended line 316c of the coil 311B in the longitudinal direction, and the slit 352 is formed to interest with the extended line 316b of the coil 311A in the longitudinal direction and an extended line 316d of the coil 311B in the longitudinal direction.

When a magnetic member, in particular a large magnetic member such as a battery is arranged near the stepping motor, a magnetic flow changing portion (for example, slit) may be provided in a portion of the large magnetic member, which is opposite to a portion near the stepping motor. The magnetic flow changing portion can prevent the external magnetism to be guided by the large magnetic member, and thus prevent the external magnetism from flowing in the neighboring stepping motor.

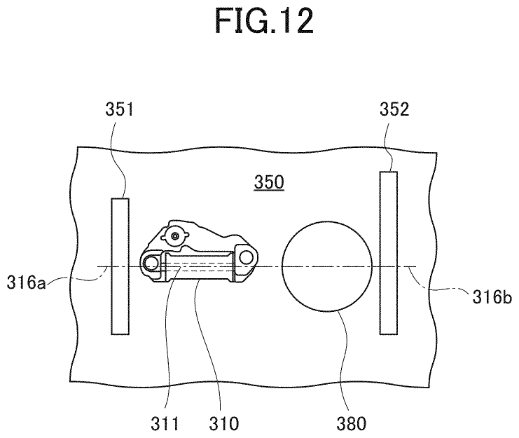

When a battery 380 is arranged instead of the stepping motor 320 with the configuration illustrated in FIG. 7 (see FIG. 12), for example, the right slit 352 of the battery 380 operates as the magnetic flow changing portion that prevents the external magnetism to be guided by the battery 380. This configuration is an example in which the battery 380 is arranged between the stepping motor 320 and the slit 352.

1. A movement of an electronic timepiece, comprising:
a stepping motor including a rotor, a stator, and a coil in which a conductive wire is wound around a coil winding core; and
a magnetic shielding plate that covers at least a part of the stepping motor, wherein
the magnetic shielding plate includes a magnetic flow changing portion that changes a magnetic flow which is directed toward the coil winding core to a magnetic flow which is not directed toward the coil winding core, and
the magnetic flow changing portion is formed in a portion of the magnetic shielding plate, which corresponds to each of extended lines from both end portions of the coil winding core, to intersect with the corresponding extended line.

2. The movement of the electronic timepiece according to claim 1, wherein the magnetic flow changing portion extends to surround a part of the stator from an outside of the stator.

3. The movement of the electronic timepiece according to claim 1, further comprising a plurality of stepping motors, the plurality of stepping motors comprising the stepping motor, wherein
the magnetic flow changing portion is provided in the magnetic shielding plate to correspond to each of the plurality of stepping motors.

4. The movement of the electronic timepiece according to claim 1, wherein the magnetic flow changing portion is a slit or a hole that penetrates through the magnetic shielding plate in a thickness direction, or a groove or a recess having a thickness thinner than that of another portion.

5. The movement of the electronic timepiece according to claim 4, wherein
the magnetic flow changing portion is the slit or the hole, and
a component in a range corresponding to a range inside an external outline of the magnetic shielding plate is arranged in the slit or the hole.

6. The movement of the electronic timepiece according to claim 1, wherein
the magnetic shielding plate includes a supporting portion as a portion that supports another component, and
the magnetic flow changing portion changes a direction of the magnetic flow to a direction toward the supporting portion.

7. The movement of the electronic timepiece according to claim 1, further comprising a ring-shaped magnetic shielding plate that surrounds the stepping motor, wherein
the ring-shaped magnetic shielding plate includes, in a part thereof in a circumference direction, a cutout, and
the stepping motor is arranged such that the extended lines becomes substantially parallel to a direction connecting the cutout and a center of the ring-shaped magnetic shielding plate.

8. The movement of the electronic timepiece according to claim 7, wherein the ring-shaped magnetic shielding plate is arranged outside two magnetic flow changing portions formed in portions which correspond to the extended lines from the both end portions of the coil winding core, respectively.

9. The movement of the electronic timepiece according to claim 1, wherein a magnetic member is arranged between the stepping motor and the magnetic flow changing portion.

10. An electronic timepiece in which the movement according to claim 1 is housed inside a case.
